(19) United States
(12) Patent Application Publication
(10) Pub. No.: US 2019/0017381 A1
(43) Pub. Date: Jan. 17, 2019

(54) METHOD AND APPARATUS FOR PASTE BACKFILL

(71) Applicant: OUTOTEC (FINLAND) OY, Espoo (FI)

(72) Inventor: Mathew REVELL, Queensland Qld (AU)

(21) Appl. No.: 16/069,018

(22) PCT Filed: Jan. 12, 2017
(86) PCT No.: PCT/FI2017/050013

§ 371 Date: Jul. 10, 2018

(30) Foreign Application Priority Data
Jan. 14, 2016 (FI) 20165020

(51) Int. Cl. E21F 15/10; B28C 9/00; B28C 7/02

(52) U.S. Cl. CPC E21F 15/10; B28C 7/02; B28C 9/004

(57) ABSTRACT

An apparatus for backfill paste includes a mixing means configured to produce paste, a storage means configured to store paste, and a feeding means configured to feed paste to a borehole. The mixing means and the storing means is formed of a combined storage and mixing means. The feeding means includes a bottom discharge port configured to feed paste from the combined storage and mixing means. The apparatus includes monitoring means configured to monitor the level of paste in the combined storage and mixing means to maintain the level of paste in the combined storage and mixing means above a setpoint value so as to prevent air from entering the borehole from the combined storage and mixing means.

### FIELD

The invention relates to a method for paste backfill as defined in the preamble of independent claim 1.

The invention also relates to apparatus for paste backfill as defined in the preamble of independent claim 7.

Paste, as used in mining applications, is characterized as a homogenous, non-segregating blend of tailings (or other dry feed material such as alluvial sand) and water either with or without a binder (such as cement). In applications using tailings paste, the consistency of the paste is typically very sensitive to water content. In order to maintain a constant consistency, which is critical to the transportation of the paste, the systems require high intensity mixing to maintain the homogeneity of the blended mixture. In mining, cemented paste can be used as backfill to stabilize underground excavations. Paste is transported either using gravity pressure head or mechanical pumping device into previously mined stopes and as it cures, forms a solid material. The paste backfill supports, for example, the walls of adjacent adits as mining progresses. Backfill is used in many mines to improve productivity, increase the percentage of ore extraction, and to reduce the cost of mining.

The paste backfill can also serve as a working platform in a mine. In short, by using paste backfill the mines can be utilized more efficiently and safely.

### Objective

The object of the invention is to simplify the paste backfill plant design by combining two components of the plant into a singular item.

### Short Description

The method for paste backfill is characterized by the definitions of independent claim 1.

Preferred embodiments of the method are defined in the dependent claims 2 to 6.

The apparatus for paste backfill is correspondingly characterized by the definitions of independent claim 7.

Preferred embodiments of the apparatus are defined in the dependent claims 8 to 13.

The invention is based on achieving a proven process condition of borehole vacuum during paste production, whilst combining the traditional paste hopper with the paste mixer.

When placing paste underground, the paste is typically transported through a system of pipes to the final destination. Introduction of air into this piping system has some negative effects. For example, if air is allowed to enter the system, an air lock can occur which stops the flow of paste temporarily until this air is released back violently into the plant through the paste hopper creating significant spillage or exhausted into the mine workings. Violent release of air is also accompanied by large impacts (such as “water hammer”) in the system leading to large stresses on pipes and the support system. Typically it is common practice to try to minimize or eliminate introduction of air by operating the system under vacuum conditions.

The vacuum is first generated by the paste falling down a vertical or inclined borehole. A paste hopper on the surface that is directly connected to the top of the borehole and level controlled so that it never runs empty, seals off the top of the borehole and prevents air entering the hole. Traditionally the paste is mixed and then discharged into a paste hopper of suitable size to maintain the vacuum conditions. In the method and in the apparatus the combined storage and mixing means eliminates the separate paste hopper. Rather the borehole is connected directly to the combined to storage and mixing means. The combined storage and mixing means both mixes the paste product and also the product volume maintained within the combined storage and mixing means creates the seal to maintain the vacuum in the borehole.

Traditionally the amount of material inside the mixer is maintained at a constant level by the use of an internal or external overflow weir. In the current invention, the material discharges from the bottom of the combined storage and mixing means and the rate of discharge is preferably controlled using a flow control device, for example a valve, such as a pinch valve. A monitoring means allows for controlling the flow out of the combined storage and mixing means and maintains the level of the top surface of the paste within the combined storage and mixing means at the set-point value, which can for example be selected so that the volume of the combined storage and mixing means contains between 40 and 50% paste. Several means for monitoring the level inside the combined storage and mixing means can be used including a pressure sensing device at the bottom of the combined storage and mixing means, nuclear sensors, and load cells for weighing the combined storage and mixing means and it's contents.

Alternatively, the paste may require a transfer pump to provide the pressure to transport the paste through the pipe distribution to it's final deposit location. In those instances, a paste hopper has traditionally been used to ensure the pump inlet is fully submerged in paste and not exposed to the atmosphere, similar to the configuration feeding into a borehole.

The method and the apparatus provides for several advantages. The apparatus can be made compact. The method and the apparatus eliminates the need for a paste hopper, which results in a smaller apparatus, in lower capital costs, in reduced cleaning during operation, and in reduced need for plant maintenance

### LIST OF FIGURES

In the following, the invention will be described in more detail by referring to the figures, of which

FIG. 1 shows a first embodiment of an apparatus for paste backfill,

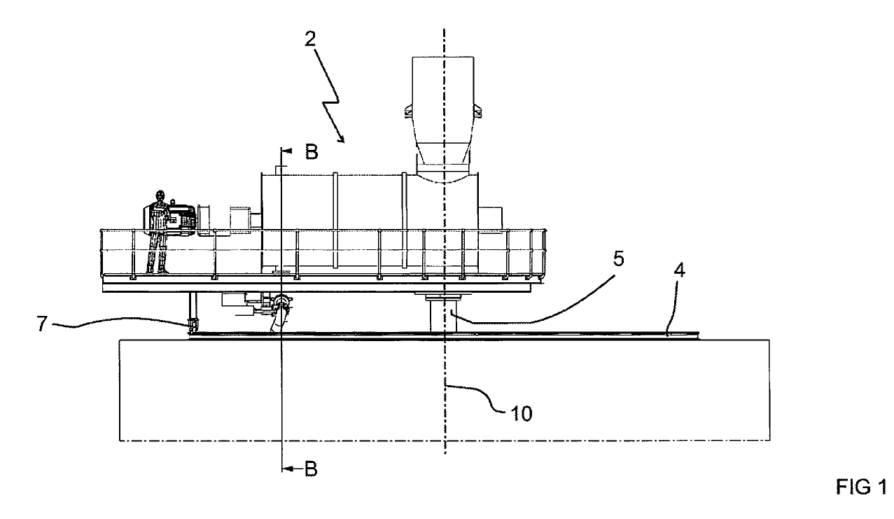

FIG. 2 shows the apparatus shown in FIG. 1 from another side,

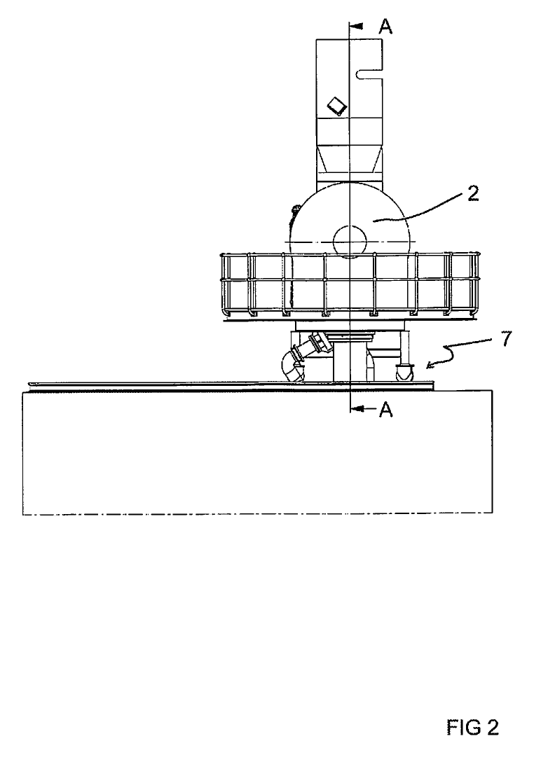

FIG. 3 shows the apparatus shown in FIG. 1 as cut along plane B-B in FIG. 1,

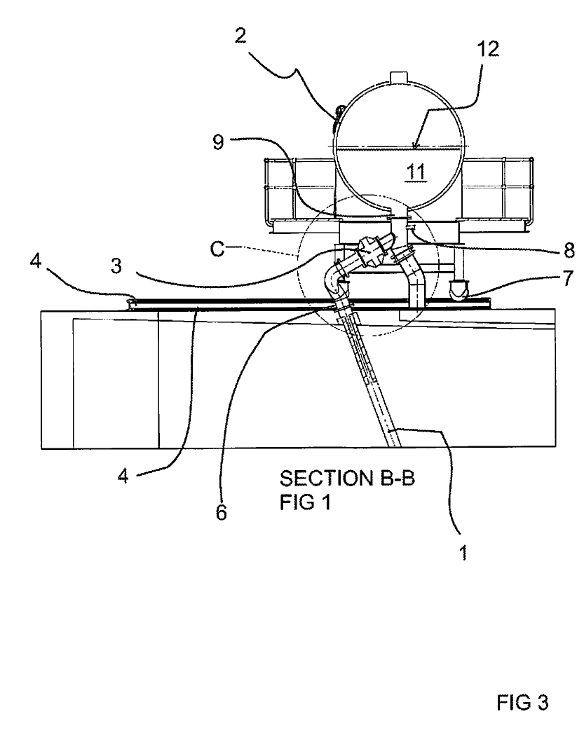

FIG. 4 shows the apparatus shown in FIG. 1 as cut along plane A-A in FIG. 2,

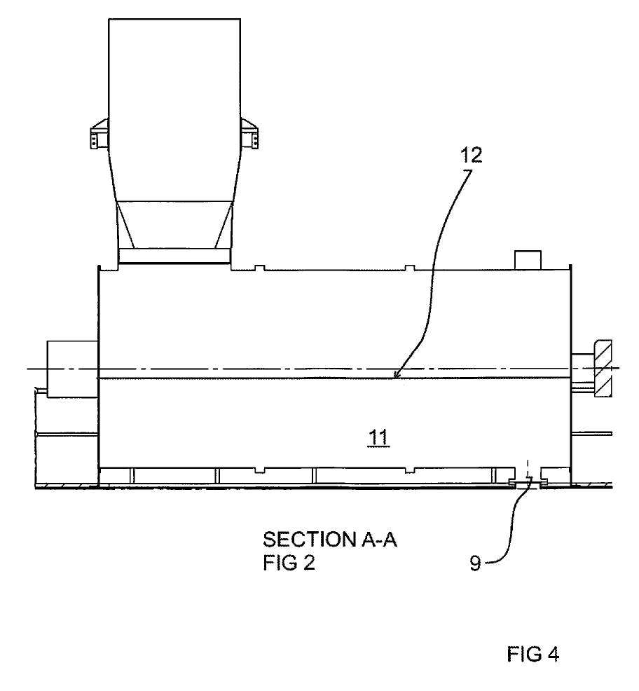

FIG. 5 shows detail C in FIG. 3 in greater scale,

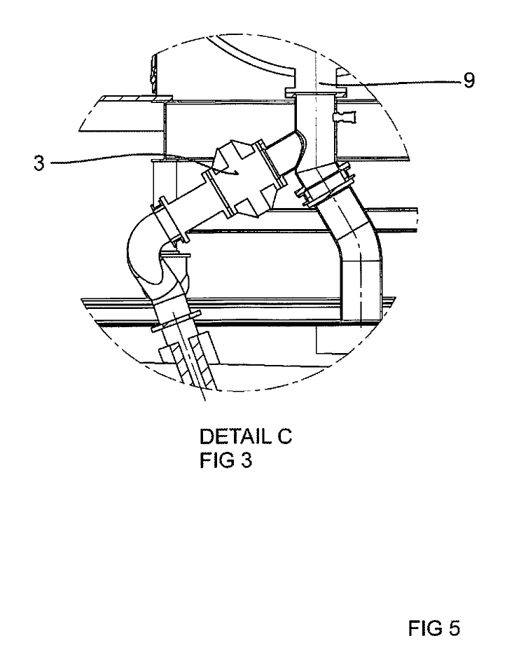

FIG. 6 shows a second embodiment of an apparatus for paste backfill,

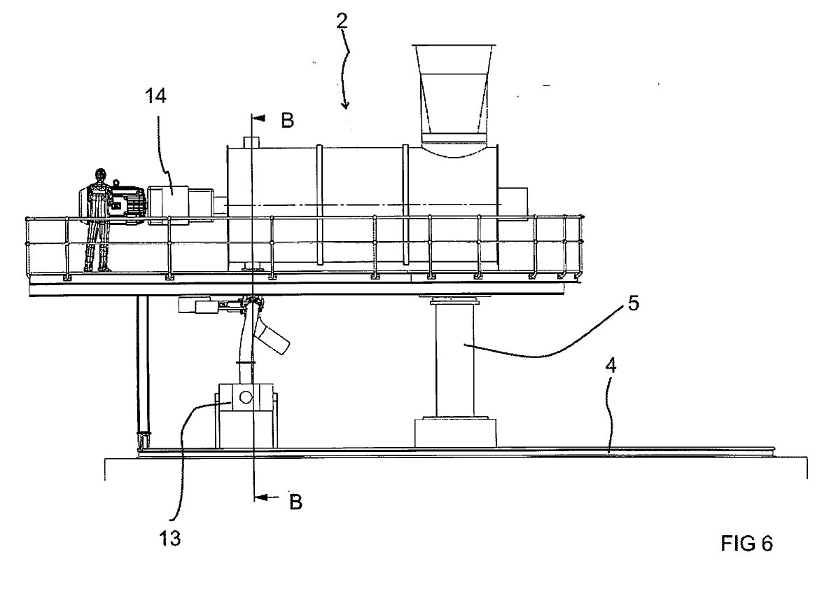

FIG. 7 shows the apparatus shown in FIG. 6 from another side,

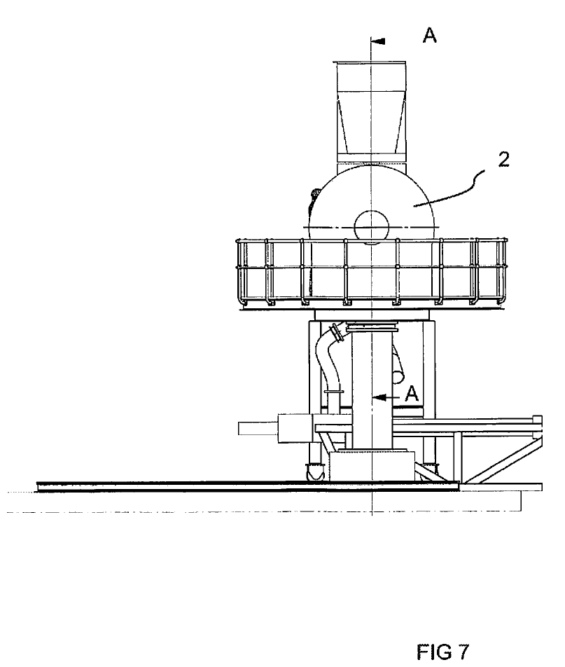

FIG. 8 shows the apparatus shown in FIG. 6 as cut along plane A-A in FIG. 7,

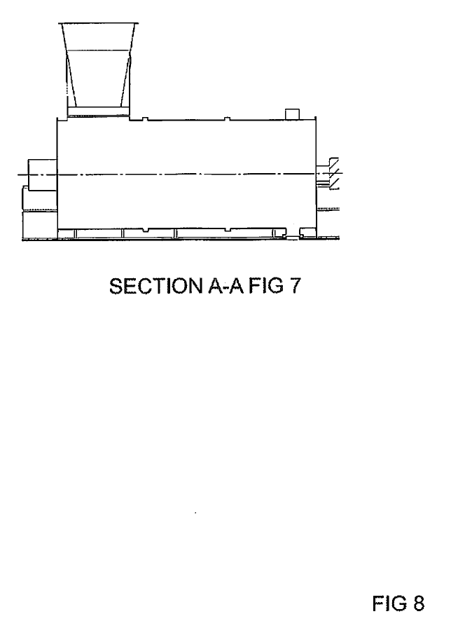

FIG. 9 shows the apparatus shown in FIG. 6 as cut along plane B-B in FIG. 6,

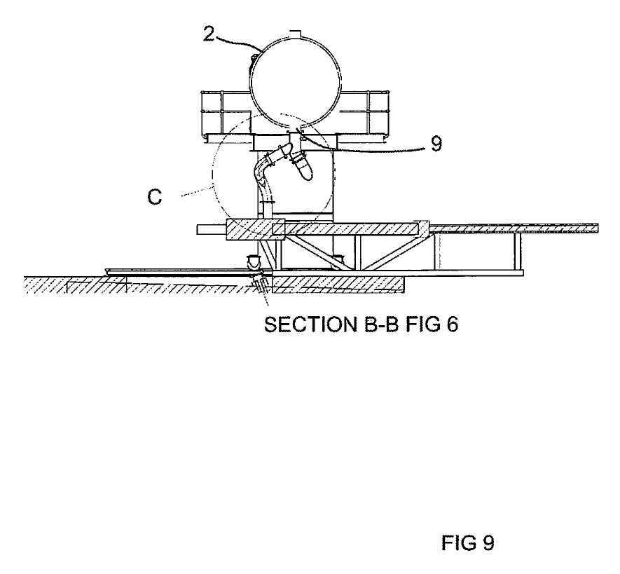

FIG. 10 shows detail C in FIG. 3 in greater scale

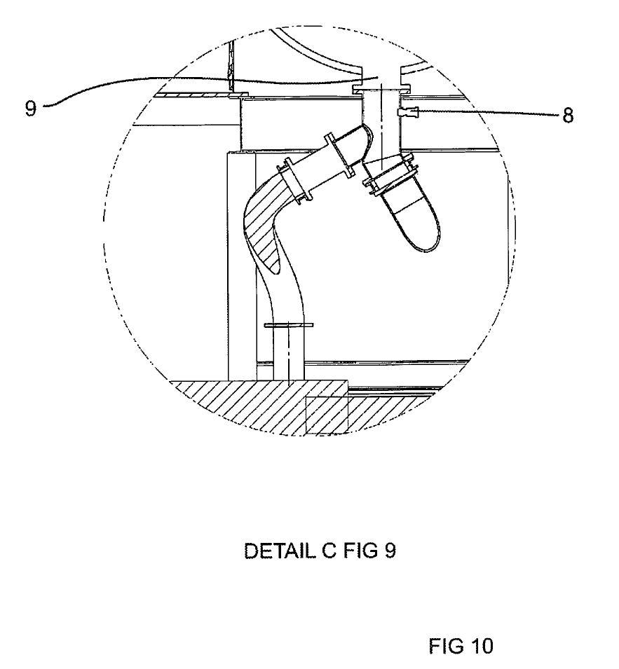

FIG. 11 shows a third embodiment of an apparatus for paste backfill,

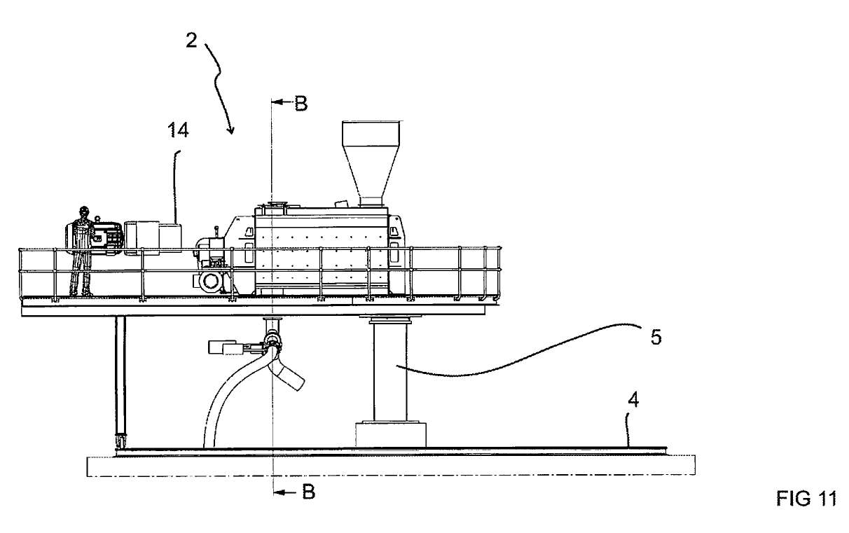

FIG. 12 shows the apparatus shown in FIG. 11 from another side,

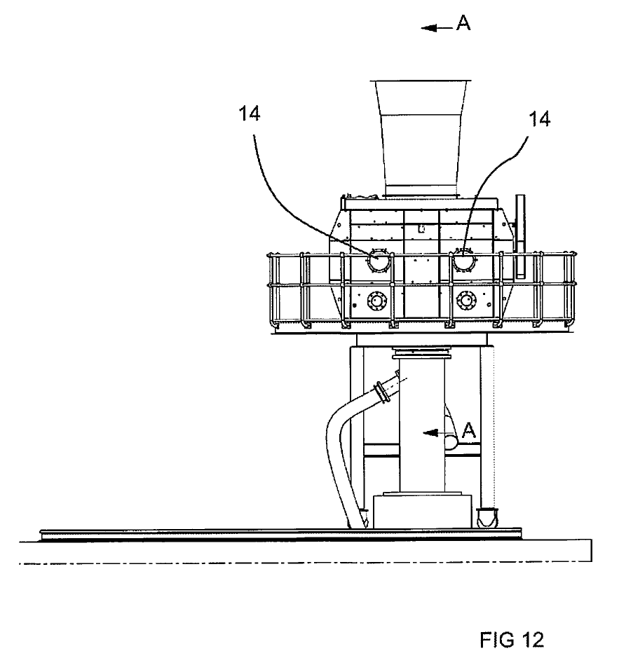

FIG. 13 shows the apparatus shown in FIG. 11 as cut along plane A-A in FIG. 12,

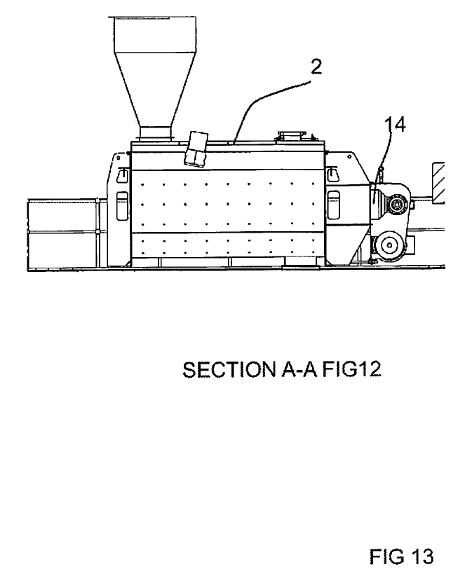

FIG. 14 shows the apparatus shown in FIG. 11 as cut along plane B-B in FIG. 11,

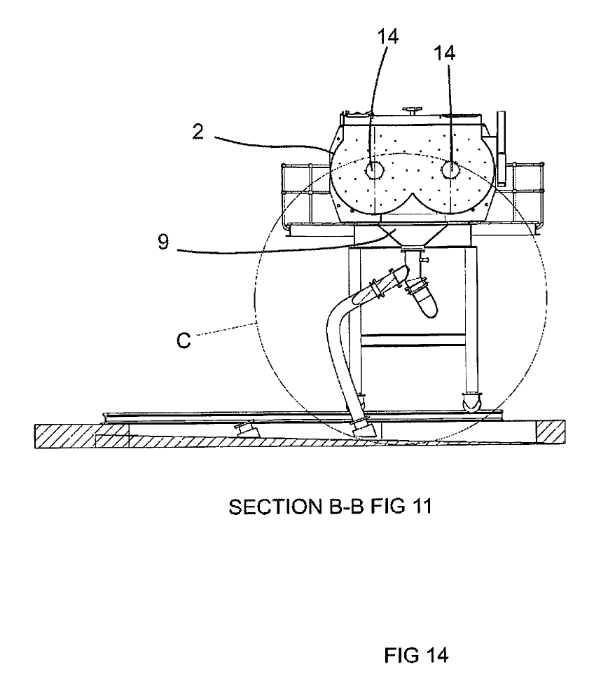

FIG. 15 shows detail C in FIG. 14 in greater scale

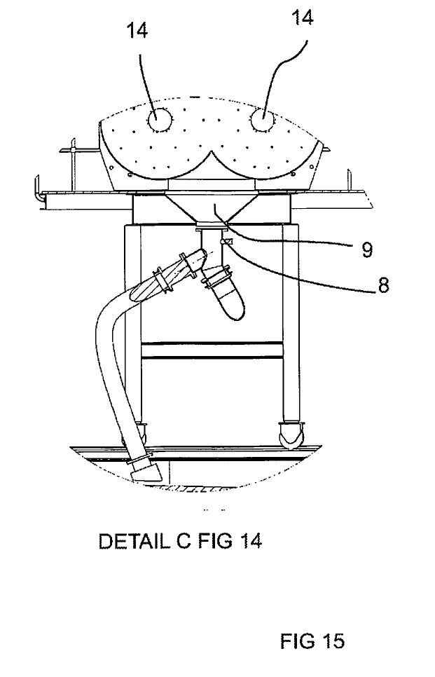

FIG. 16 shows a fourth embodiment of an apparatus for paste backfill,

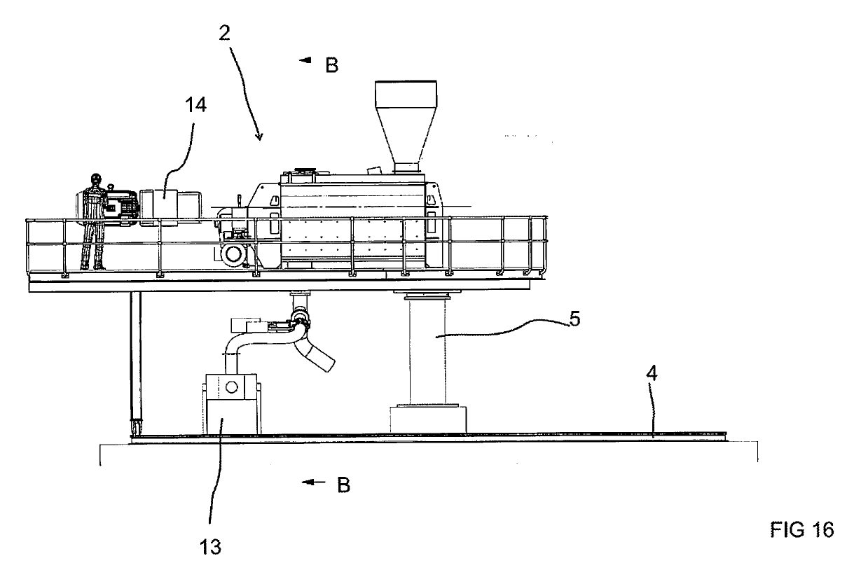

FIG. 17 shows the apparatus shown in FIG. 16 from another side,

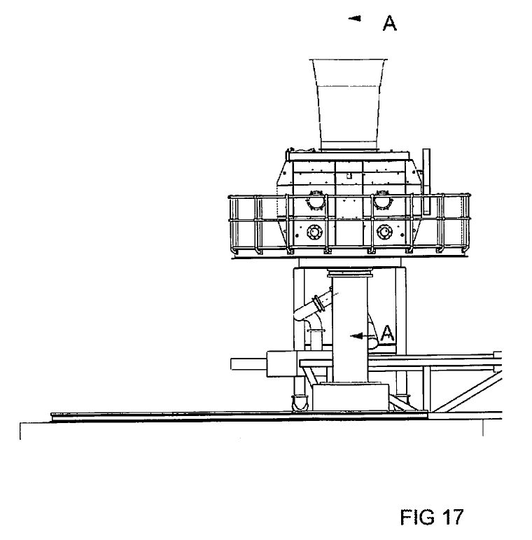

FIG. 18 shows the apparatus shown in FIG. 16 as cut along plane A-A in FIG. 17,

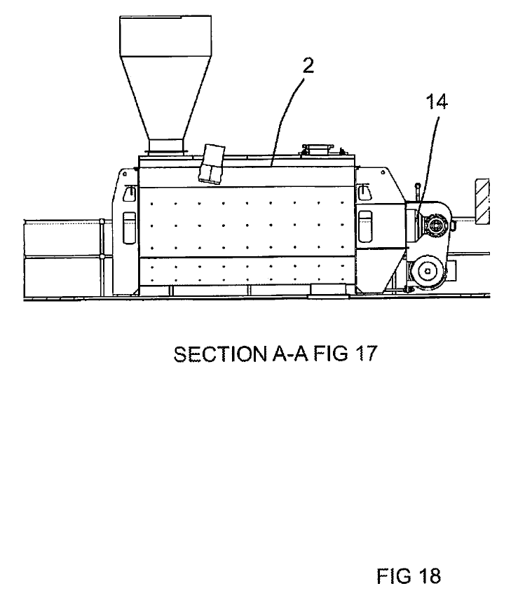

FIG. 19 shows the apparatus shown in FIG. 16 as cut along plane B-B in FIG. 16, and

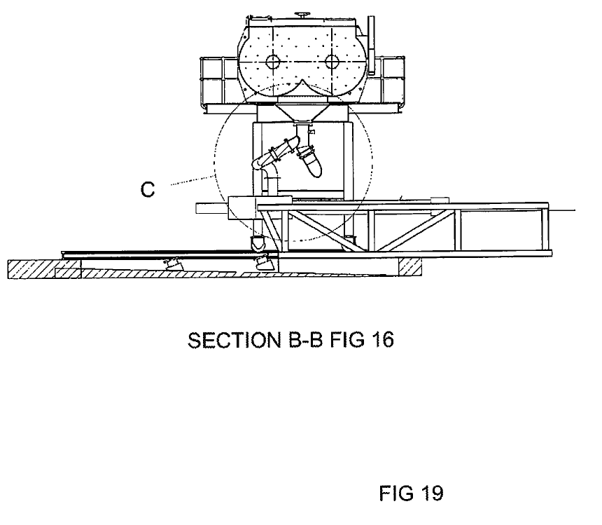

FIG. 20 shows detail C in FIG. 19 in greater scale.

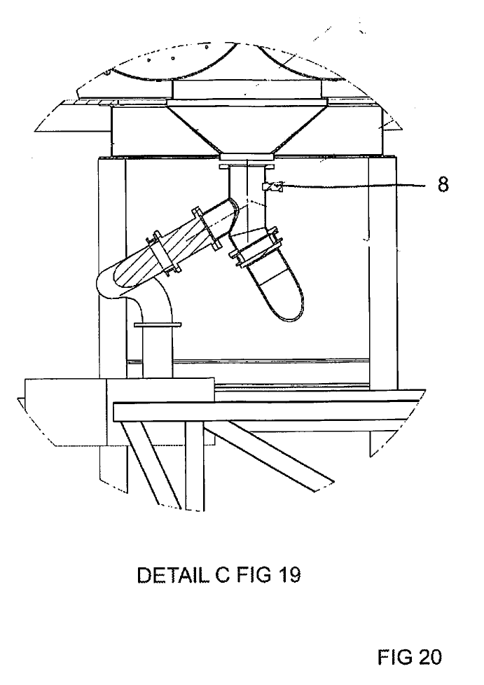

### DETAILED DESCRIPTION OF THE INVENTION

First the method for paste backfill and some embodiments and variants of the method will be described in greater detail.

The method comprises a mixing step for producing paste 11 by mixing. The method may comprise using in the mixing step a mixing means 14 for example high-intensity mixer such as one of the following: (i) a single-shaft mixer, (ii) a twin-shift mixer, (iii) a planetary mixer to provide intense mixing for generation of a homogenous, non-segregating output material.

The method comprises a storing step for storing paste 11 produced in the mixing step.

The method comprises a feeding step for feeding paste 11 into a borehole 1.

The method comprises performing the mixing step and the storing step in a combined storage and mixing means 2.

The method comprises feeding paste 11 into the borehole 1 in the feeding step from the combined storage and mixing means through a bottom discharge port 9 in the combined storage and mixing means 2.

The discharge port 9 of the combined mixing and storing means 2 is preferably arranged below the top level 12 of paste 11 in the combined mixing and storing means 2.

The method comprises monitoring the level of the top surface 12 of the paste 11 in the combined storage and mixing means 2 in the feeding step to maintain the level of paste 11 in the combined storage and mixing means 2 above a setpoint value to prevent exposure of the bottom discharge port 9 so as to prevent air from entering the borehole 1 from the combined storage and mixing means 2.

The method can comprise monitoring the level of paste 11 in the combined storage and mixing means 2 in the feeding step with a monitoring means comprising a level meter 8 in the combined storage and mixing means 2 that is functionally connected to a valve 3, preferably by means of a pinch valve.

The method can comprise providing a base 4 supporting the combined storage and mixing means 2 being at the base 4 by means of a vertical supporting member 5 between the base 4 and the combined storage and mixing means 2 so that the combined storage and mixing means 2 can be pivoted about a pivot axis 10 preferably more than 180 degrees. The pivot axis 10 is preferably, but not necessarily, vertical or near vertical. This allows full access for drilling out the boreholes in the event of blockage and also provides space for multiple boreholes to be installed. In such case, the method can comprise providing the base 4 with a plurality of apertures 6 each configured to releasable receiving the feeding means, and each being provided at a same distance from the pivot axis 10. In such case, the method can comprise providing a base 4 in the form of a circular base 4, and providing the vertical supporting member 5 in the middle of the base 4. In such case, the method can comprise supporting the combined storage and mixing means 2 by wheels 7 at the base 4.

The mixing step of the method may comprise a receiving step for receiving at least one of: (i) tailings in the form of filter cake or thickened tailings from a dewatering means, (ii) dry feed material such as dry tailings, and (iii) liquid such as water. The mixing step comprises receiving binder from a binder supplying means.

The method can comprise producing filter cake from tailings in a dewatering means and by supplying filter cake or thickened tailings from the dewatering means to the combined storage and mixing means.

The method comprises supplying binder from a binder supplying means to the combined storage and mixing means.

In the following the apparatus for paste backfill and some embodiments and variants of the apparatus will be described in greater detail.

The apparatus comprises a mixing means configured to produce paste 11 by mixing.

The apparatus comprises a storage means configured to store paste 11 produced by the mixing means.

The apparatus comprises a feeding means configured to feed paste 11 to a borehole 1.

The mixing means and the storing means is formed of a combined storage and mixing means 2 that is configured to produce paste 11, and that is configured to store paste 11.

The feeding means comprises a bottom discharge port 9 in the combined storage and mixing means 2 configured to feed paste 11 from the combined storage and mixing means 2.

The apparatus may comprise a mixing means 14, for example a high-intensity mixer such as one of the following: (i) a single-shaft mixer, (ii) a twin-shift mixer, (iii) a planetary mixer to provide intense mixing for generation of a homogenous, non-segregating output material.

The apparatus may use a reversing mixing apparatus near the bottom discharge port 9 to prevent material bypassing the mixing step.

The apparatus is preferably, but not necessarily, void of any internal overflow weir or port to maintain level of paste 11 inside the combined storage and mixing means 2.

The apparatus comprises a monitoring means configured to monitor the level of paste 11 in the combined storage and mixing means 2 to maintain the level of paste 11 in the combined storage and mixing means 2 above a setpoint value to prevent exposure of the bottom discharge port 9 so as to prevent air from entering the borehole 1 from the combined storage and mixing means 2.

The monitoring means can comprise a level meter 8 or meters, and may use one of or a combination of the following measurement methods: (i) pressure, (ii) radio waves, (iii) mass in the combined storage and mixing means 2 that is functionally connected to a valve 3 in the feeding means. The valve 3 can be a pinch valve.

The apparatus can comprise a base 4 and the combined storage and mixing means 2 can be supported at the base 4 by means of a vertical supporting member 5 between the base 4 and the combined storage and mixing means 2 so that the combined storage and mixing means 2 can be rotated about a pivot axis 10 preferably 180 degrees or more. The pivot axis is preferably, but not necessarily, vertical or near vertical. This allows full access to the borehole for drilling out in event of blockage and also provides space for multiple boreholes to be installed. In such case the base 4 can comprise a plurality of apertures 6 each configured to releasable receiving the feeding means so that said plurality of apertures 6 is provided at the same distance from the pivot axis. The base 4 can be circular, and the vertical supporting member 5 can be provided in the middle of the base 4. The combined storage and mixing means 2 can be supported by wheels 7 at the base 4.

The apparatus may comprise at least one of the following: (i) a dewatering means configured to produce filter cake or thickened tailings and configured to feed filter cake to the combined storage and mixing means 2, (ii) a dry material feeding means configured to feed dry feed material such as dry tailings or sand to the combined storage and mixing means 2, and (iii) liquid feeding means configured to feed liquid such as water or a slurry to the combined storage and mixing means 2. The apparatus comprises a binder supplying means configured to feed binder to the combined storage and mixing means 2.

The feeding means can comprise a transfer pump 13 configured to feed paste to a borehole by pumping.

It is apparent to a person skilled in the art that as technology advances, the basic idea can be implemented in various ways. The method and the apparatus and the embodiments thereof are therefore not restricted to the above examples, but they may vary within the scope of the claims.

1. A method for paste backfill comprising:
a mixing step for producing paste by mixing,
a storing step for storing paste produced in the mixing step, and
a feeding step for feeding paste into a borehole, wherein
by performing the mixing step and the storing step in a combined storage and mixing means,
by supplying binder from a binder supplying means to the combined storage and mixing means for the mixing step,
by feeding paste into the borehole in the feeding step from a bottom discharge port of the combined storage and mixing means, and
by monitoring the level of paste in the combined storage and mixing means in the feeding step to maintain the level of paste in the combined storage and mixing means in the above a set-point value to prevent exposure of the bottom discharge port so as to prevent air from entering the borehole from the combined storage and mixing means.

2. The method according to claim 1, further comprising:
monitoring the level of paste in the combined storage and mixing means with a monitoring means comprising at least one level meter in the combined storage and mixing means that is functionally connected to a valve in the feeding means.

3. The method according to claim 2, wherein the monitoring means comprises at least one level meter including at least one of the following measurement methods: (i) pressure, (ii) radio waves, (iii) mass in the combined storage and mixing means that is functionally connected to a valve in the feeding means.

4. The method according to claim 1, further comprising:
processing tailings in a dewatering means, and
supplying tailings from the dewatering means to the combined storage and mixing means for the mixing step.

5. The method according to claim 1, further comprising arranging the discharge port of the combined mixing and storing means below the top level of paste in the combined mixing and storing means

6. The method according to claim 1, further comprising controlling the feeding of paste in the feeding step from the bottom discharge port of the combined storage and mixing means of a valve, preferably by means of a pinch valve.

7. An apparatus for paste backfill, the apparatus comprising:
a mixing means configured to produce paste by mixing,
a storage means configured to store paste, and
a feeding means configured to feed paste to a borehole
wherein
the mixing means and the storing means being formed of a combined storage and mixing means that is configured to produce paste, and that is configured to store paste,
a binder supplying means configured to store binder and configured to supply binder into the combined storage and mixing means,
the feeding means comprising a bottom discharge port configured to feed paste from the combined storage and mixing means, and
monitoring means configured to monitor the level of paste in the combined storage and mixing means to maintain the level of paste in the combined storage and mixing means above a setpoint value to prevent exposure of the bottom discharge port so as to prevent air from entering the borehole from the combined storage and mixing means.

8. The apparatus according to claim 7, wherein the monitoring means comprises at least one level meter.

9. The apparatus according to claim 7, wherein the mixing means comprises a high-intensity mixer selected from the group consisting of (i) a single-shaft mixer, (ii) a twin-shift mixer, (iii) a planetary mixer to provide intense mixing for generation of a homogenous, non-segregating output material.

10. The apparatus according to claim 7, wherein
the mixing means being void of an internal overflow weir or port, and
the mixing means using a reversing mixing apparatus to prevent material bypassing the mixing step,

11. The apparatus according to claim 7, further comprising:
a dewatering means configured to produce dewatered tailings, and
the dewatering means being configured to feed dewatered tailings into the combined storage and mixing means.

12. The apparatus according to claim 7, wherein the feeding means comprises a transfer pump configured to feed paste to a borehole by pumping.

13. The apparatus according to claim 7, further comprising:
a valve, configured to control the feeding of paste from the bottom discharge port of the combined storage and mixing means wherein
the valve is functionally connected to the monitoring means.
